(19) United States
(12) Patent Application Publication
(10) Pub. No.: US 2026/0210776 A1
(43) Pub. Date: Jul. 23, 2026

(54) THERMOPLASTIC COIL SPACER

(71) Applicant: One Power Company, Findlay, OH (US)

(72) Inventors: Jereme Kent, Findlay, OH (US); Erica Johnson, Findlay, OH (US); Brian Curkendall, Findlay, OH (US); Richard Bohon, Findlay, OH (US); Cooper Coughlin, Findlay, OH (US)

(73) Assignee: One Power Company, Findlay, OH (US)

(21) Appl. No.: 19/451,117

(22) Filed: Jan. 16, 2026

Related U.S. Application Data
(60) Provisional application No. 63/746,487, filed on Jan. 17, 2025.

(51) Int. Cl. G01K 11/32; H01F 27/28; H01F 27/40

(52) U.S. Cl. CPC G01K 11/32; H01F 27/2876; H01F 27/402; H01F 2027/406

(57) ABSTRACT

In various embodiments, a coil spacer includes a first slot section and a second slot section for receiving corresponding coil sections. The coil sections are either radially spaced apart in the case of a disc-shaped spacer or axially spaced apart in the case of a cylindrical spacer, with respect to a central axis. The coil spacer is composed of a hydrophobic thermoplastic. The spacer is configured to inhibit electrical communication between corresponding coil sections. The spacer further includes a plurality of cooling channels configured to guide coolant within a transformer.

### FIELD

The disclosure relates to the field of transformers. More specifically, the disclosure relates to transformer coils. Selected examples relate to thermoplastic coil spacers and transformers, and methods of monitoring coils.

### BACKGROUND

Transformers generally include one or more electrically conductive coils that are wound to generate or transfer electromagnetic energy. These coils are often arranged in multiple layers or sections, separated by insulating spacers or barriers to maintain proper electrical clearances. Traditional spacers, such as those formed from paper-based or cellulose-based materials such as wood, have been widely used due to their availability, cost-effectiveness, and acceptable insulating properties. However, conventional materials may absorb moisture, degrade over time, and have non-conducive mechanical or thermal characteristics when subjected to the operational conditions of transformers, such as elevated temperatures, mechanical stress from vibrations, and exposure to dielectric fluids and oils. Additionally, monitoring the conditions within a coil assembly may be difficult with existing spacer materials, as they are not always suited for integration with sensing elements. Thus, there is a need for improved spacers, transformers, and methods of monitoring coils.

### Brief Summary of Selected Examples

Various examples of thermoplastic coil spacers, transformers, and methods of monitoring are described herein.

An example transformer comprises an electrically conductive coil and a hydrophobic coil spacer. The coil defines a central axis. The coil includes a first coil section as well as a second coil section which is radially spaced apart from the first coil section with respect to the central axis. The spacer is configured to receive and partially house the electrically conductive coil. The spacer is further configured to inhibit electrical communication between the first coil section and the second coil section.

Another example of a transformer comprises an electrically conductive coil and a hydrophobic coil spacer. The coil defines a central axis. The coil includes a first coil section and a second coil section which is axially spaced apart from the first coil section with respect to the central axis. The spacer is configured to receive and partially house the electrically conductive coil. The spacer is further configured to inhibit electrical communication between the first coil section and the second coil section.

An example coil spacer comprises a hydrophobic thermoplastic disc. The disc defines a central aperture which further defines a central axis. The disc further defines a first slot section and a second slot section. Each of the first slot section and the second slot section is configured to receive a corresponding coil section from a plurality of coil sections of a coil such that a first coil section of the plurality of coil sections is radially spaced apart from a second coil section with respect to the central axis

Another example coil spacer comprises a hydrophobic thermoplastic cylinder. The cylinder defines a central aperture which further defines a central axis. The cylinder further defines a first slot section and a second slot section. Each of the first slot section and the second slot section is configured to receive a corresponding coil section from a plurality of coil sections of a coil, such that a first coil section of the plurality of coil sections is axially spaced apart from a second coil section with respect to the central axis.

An example coil monitoring method comprises providing a hydrophobic thermoplastic first disc. The monitoring method further comprises disposing a hydrophobic thermoplastic second disc adjacent to the first disc such that the first disc and second disc combine to define a gap. Even further, the monitoring method further comprises disposing a temperature sensor within the gap. The first disc defines a first central aperture that further defines a central axis. The first disc further defining a first slot section and a second slot section. Each of the first slot section and second slot section is configured to receive a corresponding coil section from a plurality of coil sections of a coil such that a first coil section of the plurality of coil sections is radially spaced apart from a second coil section with respect to the central axis. The second disc that defines a second central aperture that further defines a central axis. Each of the third slot section and the fourth slot section is configured to receive a corresponding coil section from the plurality of coil sections of the coil such that a third coil section of the plurality of coil sections is radially spaced apart from a fourth coil section with respect to the central axis.

Another example coil monitoring method comprises providing a hydrophobic thermoplastic first cylinder. The monitoring method further comprises disposing a hydrophobic thermoplastic second cylinder concentric to the first cylinder such that the first cylinder and second cylinder combine to define a gap. Even further, the monitoring method further comprises disposing a temperature sensor within the gap. The first cylinder defines a first central aperture that further defines a central axis. The first cylinder further defining a first slot section and a second slot section. Each of the first slot section and second slot section is configured to receive a corresponding coil section from a plurality of coil sections of a coil such that a first coil section of the plurality of coil sections is axially spaced apart from a second coil section with respect to the central axis. The second cylinder defines a second central aperture that further defines a central axis. Each of the third slot section and the fourth slot section is configured to receive a corresponding coil section from the plurality of coil sections of the coil such that a third coil section of the plurality of coil sections is axially spaced apart from a fourth coil section with respect to the central axis adjacent to the first cylinder.

### BRIEF DESCRIPTION OF FIGURES

FIG. 1 is a detailed view of a disc spacer pair.

FIG. 2A is a top-down view of the disc spacer pair illustrated in FIG. 1.

FIG. 2B is a side view of the disc spacer pair illustrated in FIG. 1.

FIG. 3 is an exploded view of a first cylindrical spacer.

FIG. 4 is an exploded view of a second cylindrical spacer.

FIG. 5A is a top-down view of the first cylindrical spacer illustrated in FIG. 3.

FIG. 5B is a side view of the first cylindrical spacer illustrated in FIG. 3.

FIG. 6A is a top-down view of the second cylindrical spacer illustrated in FIG. 4.

FIG. 6B is a side view of the second cylindrical spacer illustrated in FIG. 4.

FIG. 7 is a diagram illustration of a high-ratio transformer.

FIG. 8 is a perspective view of a coil installed in a disc spacer.

FIG. 9 is a perspective view of a coil installed in a plurality of disc spacers.

FIG. 10 is an exploded view of a coil installed in a plurality of disc spacers.

FIG. 11 is a diagram illustration of a low ratio transformer.

FIG. 12 is an exploded view of a coil installed in plurality of cylindrical spacers.

### DETAILED DESCRIPTION OF SELECTED EXAMPLES

The following detailed description and the appended drawings describe and illustrate various example thermoplastic coil spacers. The description and drawings are provided to enable one skilled in the art to make and use one or more example thermoplastic coil spacers. They are not intended to limit the scope of the claims in any manner.

In various examples, a transformer may be employed to adjust certain parameters of an electrical signal from a first set of values to a second set of values. For instance, a transformer may be configured to convert a high-current and low-potential electrical signal into a low-current and high-potential electrical signal, commonly referred to as a step-up configuration. A step-up configuration may facilitate the efficient transmission of electrical energy over substantial distances, as reducing current at high voltage levels can decrease energy losses associated with long-distance power lines. Conversely, a transformer may be configured to convert a low-current and high-potential electrical signal into a high-current and low-potential electrical signal, often referred to as a step-down configuration. Such a step-down configuration may be used, for example, to provide electrical signals at safer and more practical voltage levels to facilities that may not be suited to manage higher potential values. In this manner, a transformer may be applied to numerous scenarios and operational environments to ensure compatibility between various types of electrical supply and load systems.

A transformer may be housed within an enclosure configured to maintain and protect internal components. Such a housing may be constructed and arranged to withstand environmental conditions and may be configured to hold one or more forms of coolant. The coolant, which can be an oil-based fluid, may be applied to assist with heat management by transferring thermal energy away from the transformer components during operation. Maintaining a controlled thermal environment may preserve the performance, reliability, and longevity of the transformer.

Within the housing, the transformer may include a core. This core may be formed from laminated iron or other materials exhibiting suitable magnetic properties. Such materials may be chosen for their ability to provide a path with low magnetic reluctance and high magnetic permeance, enabling the transformer to effectively direct magnetic flux. By doing so, the transformer may reduce unnecessary magnetic flux losses to spatial uncertainty or conversion into heat. This path may guide magnetic fields between windings, allowing the transformer to operate more efficiently while minimizing energy losses.

The transformer includes an input portion configured to receive an electrical signal of a first set of electrical parameters such as a first set of a potential value, a current value, a phase angle, and a power level. This input portion may be connected to an electrical supply source. The transformer further includes an output portion configured to distribute an electrical signal having a second set of parameters. The second set of parameters may differ from the first set in potential value, current value, or other electrical characteristics, depending on the transformer's configuration and intended application.

Transformers may include at least one winding configured to facilitate electromagnetic communication between the input portion, the output portion, and the core. The winding may be formed from electrically conductive material, such as copper or aluminum. A primary winding may be configured to receive the first electrical signal and to generate a magnetic field that couples to a secondary winding. The secondary winding may similarly be configured to receive and induce a second electrical signal as a function of the magnetic coupling with the primary winding and the core. The resulting conversion of electrical parameters at the secondary winding may be configured to suit various requirements, such as elevating the potential level for transmission or reducing it for lower potential applications. Each winding may include multiple turns and may be arranged in a manner that facilitates electromagnetic coupling, reduces undesired losses, and allows for stable and predictable performance.

A transformer may be configured in multiple configurations, including single-phase or three-phase arrangements. A single-phase transformer may incorporate a single primary winding and a single secondary winding. In contrast, a three-phase transformer may include three primary windings and three secondary windings arranged to accommodate polyphase electrical systems. Such three-phase configurations may be arranged in various patterns, such as delta or star (wye) configurations. Each configuration may present differing functions in terms of voltage levels, current distribution, and symmetry of load handling. For instance, a delta configuration may avoid certain circulating currents in specific applications, while a star configuration may simplify the provision of a neutral point for grounding or for distributing power at different potential levels.

In various examples, a transformer coil may be constructed according to one or more winding types. Each winding type may be selected to have predetermined electrical characteristics, thermal performance, and mechanical properties. These types may include, for example, helical windings and cross over or disc type windings.

A helical winding type may be arranged so that consecutive turns of conductor material proceed in a helical or spiral pattern along a coil form. This arrangement may be configured to produce an electrical path that extends longitudinally, allowing each conductor turn to advance systematically from one end of the coil form to the other. The conductor material used in a helical winding may include, but is not limited to, copper or aluminum, and the size, shape, and number of turns may be selected to yield predetermined current and potential values.

A cross over winding type may be arranged so that conductor segments intersect or cross over from one layer of winding to another at designated intervals. This arrangement may be configured to achieve targeted electromagnetic coupling patterns and to control voltage gradients across the coil. A cross over approach may allow conductors to be arranged in layers or discs with defined spacing and controlled overlaps. The conductor material used in a cross over winding may include, but is not limited to, copper or aluminum, and the size, shape, and number of turns may be selected to yield predetermined current and potential values.

In many transformer configurations, spacers may be positioned between coil sections to maintain proper mechanical separation and dielectric clearances. These spacers may be configured to ensure that adjacent coil sections do not come into unintended electrical contact and to provide a stable platform for coil layers. By positioning coil sections at predetermined distances, spacers may assist in controlling the distribution of the electric field, reducing localized stress, and preventing electrical breakdown. Spacers may also be arranged and shaped to facilitate the flow of coolant around the coil, thereby enhancing thermal management within the transformer.

Spacers may serve several purposes. They may be configured to maintain physical gaps between coil sections, ensuring that conductors remain properly aligned and secured. Spacers may be arranged to influence the local dielectric environment, reducing the likelihood of partial discharge events that may occur when high-voltage gradients or voids exist within the coil assembly. Spacers may also help channel cooling fluids through the coil structure.

Spacers may be configured to exhibit specific electrical properties. For examples, some spacers possess a dielectric strength sufficient to withstand the electric fields present during normal and transient operating conditions. They may also have a dielectric constant and loss factor compatible with the transformer’s insulation system, so that their presence does not significantly degrade the overall dielectric performance. In some cases, the spacers may be configured to resist moisture absorption, as moisture can reduce dielectric strength and increase the risk of electrical discharges. Appropriate material selection may ensure that spacers retain stable electrical properties across a range of temperatures and while exposed to transformer oils or other dielectric fluids.

In certain embodiments, constructing spacers from thermoplastics may be advantageous in contest of thermal and dielectric performance. A thermoplastic spacer may be configured to withstand both steady-state thermal loads and transient temperature variations within a transformer. This includes handling elevated operating temperatures in the coil region as well as tolerating localized temperature gradients that occur due to uneven heating or distinct operational conditions.

Thermoplastic materials suitable for spacers may also possess dielectric properties that support proper electrical insulation. Such materials may be configured to provide the necessary dielectric strength to resist electrical breakdown, as well as maintain appropriate dielectric constants and loss factors. Additionally, many thermoplastics are hydrophobic. Hydrophobic characteristics may allow spacers constructed of these materials to maintain low moisture content, ensuring consistent configured dielectric parameters. Because they inherently resist moisture absorption, such thermoplastic spacers may not require a baking process to reduce water content prior to installation. By eliminating the conventional baking step, it may be possible to streamline the assembly process of a coil within a transformer. Example thermoplastics such as polyphenylene sulfide plastics or liquid crystal polymer plastics may be suitable use to construct spacers. Thermoplastic materials used for spacers generally remain stable when exposed to typical coolants like mineral oil and FR3. Additionally, they may retain their mechanical properties at temperatures exceeding 250°F. Even further, thermoplastic materials may be injection molded into complex shapes suitable for the construction of a transformer.

In addition to the stability of these plastics in typical coolants such as mineral oil and FR3, thermoplastic materials suitable for spacers often provide key dielectric properties to ensure proper electrical insulation. They can offer the dielectric strength needed to resist electrical breakdown, maintain appropriate dielectric constants, and exhibit low loss factors. Many of these thermoplastics are naturally hydrophobic, enabling the resulting spacers to hold minimal moisture and retain consistent insulation performance over time. Moreover, because they inherently repel water, there is generally no need for baking to reduce moisture content prior to installation—a step that can otherwise slow transformer assembly. By removing the traditional baking process, the overall coil-building procedure may become more efficient. Examples of such thermoplastics include polyphenylene sulfide plastics and liquid crystal polymer plastics, both of which can be well-suited to fabricating spacers in high-performance transformer applications. While both polyphenylene sulfide plastics and liquid crystal polymer plastics are presented, these are merely exemplary, as other high-performance thermoplastics may be suitable.

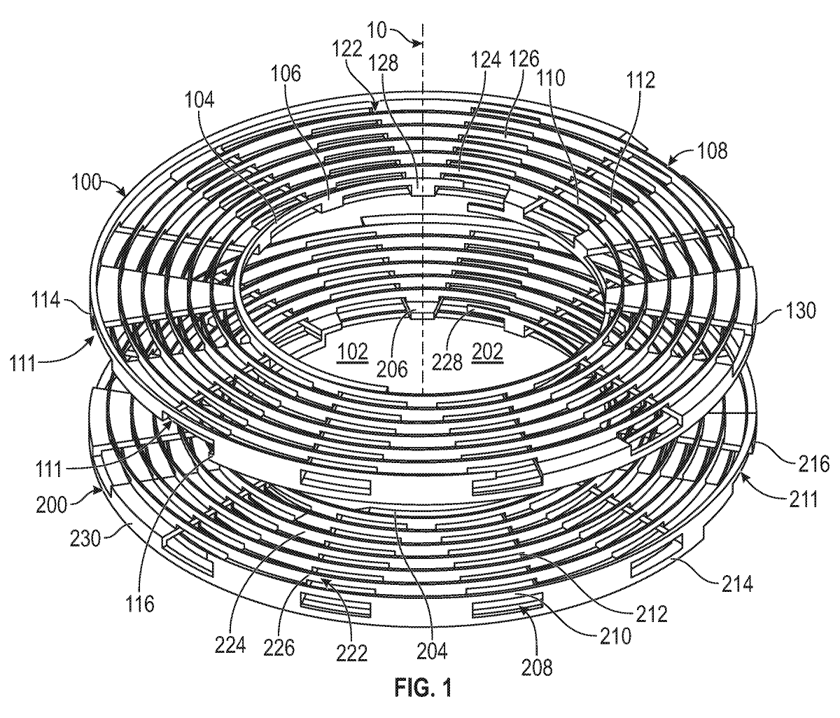

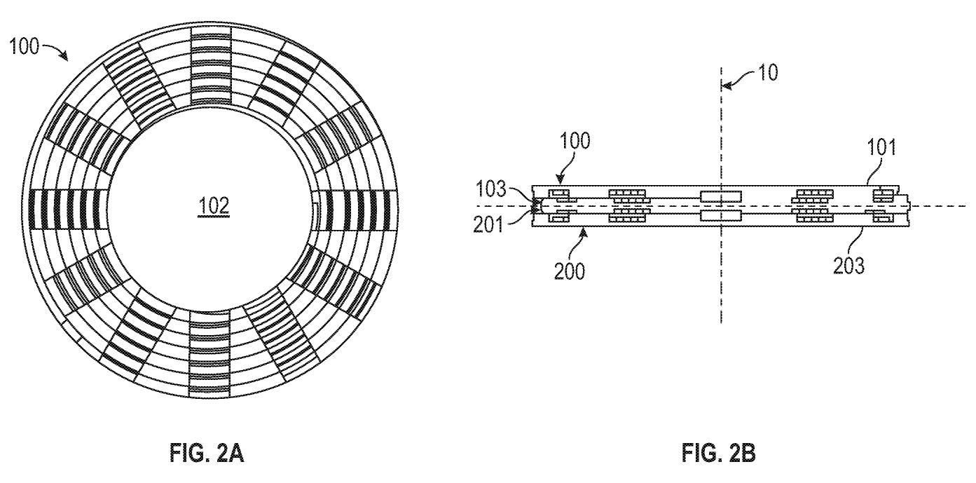

Each of FIGS. 1 and 2 illustrates a spacer disc pair of a first spacer disc 100 and a second spacer disc 200. In various embodiments, the first spacer disc 100 may be a disc. The first spacer disc 100 may be circular or any other suitable shape such as, but not limited to, rectangular and hexagonal. The first spacer disc 100 may define a central axis 10, and more particularly, a first disc central aperture 102 may define the central axis 10. The first spacer disc 100 may include a first disc inner perimeter 104 and a first disc outer perimeter 106. The first disc inner perimeter 104 may be used to define the first disc central aperture 102. The first disc inner perimeter 104 may be radially spaced apart from the central axis 10 by a predetermined distance. The first disc inner perimeter 104 may be used to define a first disc inner surface 128. The first disc outer perimeter 106 may be radially spaced apart from the central axis 10 by a predetermined distance. The first disc outer perimeter 106 is radially spaced apart from the central axis 10 at a greater distance than the first disc inner perimeter 104. The first disc outer perimeter 106 may be used to define a first disc outer surface 130. The first spacer disc 100 defines a first disc top plane 101. The first disc top plane 101 may extend between the first disc inner perimeter 104 and the first disc outer perimeter 106. The first spacer disc 100 also defines a first disc bottom plane 103. The first disc bottom plane 103 may extend between the first disc inner perimeter 104 and the first disc outer perimeter 106. The first disc bottom plane 103 may be disposed opposite and parallel to the first disc top plane 101.

The first spacer disc 100 includes a first spiral slot 122. The first spiral slot 122 may be defined by at least one of the first disc top plane 101 and the first disc bottom plane 103. The first spiral slot 122 may be defined by a portion of the first spacer disc 100 that extends between the first disc inner surface 128 and the first disc outer surface 130. The first spiral slot 122 may be used to hold a conductor of a coil. In some embodiments, the first spiral slot 122 may be configured to hold a single turn of a coil. In other embodiments, the first spiral slot 122 may be configured to hold a predetermined number of turns in a coil. In such embodiments, a first portion of the coil may be insulated from another portion of the coil through insulators such as, but not limited to, enamel. The first spiral slot 122 may be generally in the shape of a spiral. In some embodiments, the spiral may be a broken spiral. The turns of the spiral may not be uniform. The first spiral slot 122 may have non-spiral portions configured to facilitate a cross over portion of a coil. The first spiral slot 122 may include a first disc slot section 124 and a second disc slot section 126. The first disc slot section 124 may be configured to retain a first portion of a coil. The second disc slot section 126 may be configured to retain a second portion of a coil. In such a configuration, the first disc slot section 124 and the second disc slot section 126 may work to inhibit direct electrical communication between the two portions of the coil, as this may cause an unwanted short circuit. In some embodiments, the first disc slot section 124 may be radially spaced apart from the second disc slot section 126 to facilitate the electrical communication inhibition.

The first spacer disc 100 includes a first plurality of vertical cooling channels 108 and a first plurality of horizontal cooling channels 111. The first plurality of vertical cooling channels 108 may be used to allow coolant to flow throughout various portions of a coil. The first plurality of vertical cooling channels 108 may be disposed between the first disc top plane 101 and the first disc bottom plane 103. The first plurality of vertical cooling channels 108 includes a first vertical cooling channel 110. The first vertical cooling channel 110 may be radially spaced apart from the central axis 10 by a predetermined distance. The first vertical cooling channel 110 may be disposed on the first disc top plane 101. In other embodiments, the first vertical cooling channel 110 may be disposed on the first disc bottom plane 103. The first vertical cooling channel 110 may run between the first disc top plane 101 and one of the first disc bottom plane 103, the first disc outer surface 130, and the first inner surface 128. The first vertical cooling channel 110 may run between the first disc bottom plane 103 and one of the first disc bottom plane 103, the first disc outer surface 130, and the first inner surface 128. In addition to the first vertical cooling channel 110, the first plurality of vertical cooling channels 108 may include a second vertical cooling channel 112. The second vertical cooling channel 112 may also be radially spaced apart from the central axis 10 a predetermined distance. The second vertical cooling channel 112 may be further spaced apart from the central axis 10 than the first vertical cooling channel 110. In some embodiments, the second vertical cooling channel 112 may be radially aligned with the first vertical cooling channel 110. The second vertical cooling channel 112 may be disposed on the first disc top plane 101. In other embodiments, the second vertical cooling channel 112 may be disposed on the first disc bottom plane 103. The second vertical cooling channel 112 may run between the first disc top plane 101 and one of the first disc bottom plane 103, the first disc outer surface 130, and the first inner surface 128. The second vertical cooling channel 112 may run between the first disc bottom plane 103 and one of the first disc bottom plane 103, the first disc outer surface 130, and the first inner surface 128.

The first plurality of horizontal cooling channels 111 includes a first horizontal cooling channel 114. The first horizontal cooling channel 114 may be disposed on the first disc inner surface 128. In other embodiments, the first horizontal cooling channel 114 may be disposed on the first disc outer surface 130. The first horizontal cooling channel 114 may run between the first disc inner surface 128 and one of the first disc outer surface 130, the first disc top plane 101, and the first disc bottom plane 103. The first horizontal cooling channel 114 may run between the first disc outer surface 130 and one of the first disc inner surface 128, the first disc top plane 101, and the first disc bottom plane 103. The first plurality of horizontal cooling channels 111 includes a second horizontal cooling channel 116. The second horizontal cooling channel 116 may be axially spaced apart from the first horizontal cooling channel 114. The second horizontal cooling channel 116 may be axially aligned with the first horizontal cooling channel 114. The second horizontal cooling channel 116 may be disposed on the first disc inner surface 128. In other embodiments, the second horizontal cooling channel 116 may be disposed on the first disc outer surface 130. The second horizontal cooling channel 116 may run between the first disc inner surface 128 and one of the first disc outer surface 130, the first disc top plane 101, and the first disc bottom plane 103. The second horizontal cooling channel 116 may run between the first disc outer surface 130 and one of the first disc inner surface 128, the first disc top plane 101, and the first disc bottom plane 103.

In various embodiments, a second spacer disc 200 may be a disc. The second spacer disc 200 may be circular, or any suitable shape such as, but not limited to, rectangular and hexagonal. The second spacer disc 200 may define the central axis 10, and more particularly, the second disc central aperture 202 may define the central axis 10. The second spacer disc 200 may include a second disc inner perimeter 204 and a second disc outer perimeter 206. The second disc inner perimeter 204 may be used to define the second disc central aperture 202. The second disc inner perimeter 204 may be radially spaced apart from the central axis 10 by a predetermined distance. The second disc inner perimeter 204 may be used to define a second disc inner surface 228. The second disc outer perimeter 206 may be radially spaced apart from the central axis 10 by a predetermined distance. The second disc outer perimeter 206 may be radially spaced apart from the central axis 10 at a greater distance than the second disc inner perimeter 204. The second disc outer perimeter 206 may be used to define a second disc outer surface 230. The second spacer disc 200 defines a second disc top plane 201. The second disc top plane 201 may extend between the second disc inner perimeter 204 and the second disc outer perimeter 206. The second spacer disc 200 also defines a second disc bottom plane 203. The second disc bottom plane 203 may extend between the second disc inner perimeter 204 and the second disc outer perimeter 206. The second disc bottom plane 203 may be disposed opposite and parallel to the second disc top plane 201.

The second spacer disc 200 includes a second spiral slot 222. The second spiral slot 222 may be defined by at least one of the second disc top plane 201 and the second disc bottom plane 203. The second spiral slot 222 may be defined by a portion of the second spacer disc 200 that extends between a second disc inner surface 228 and the second disc outer surface 230. The second spiral slot 222 may be used to hold a conductor of a coil. In some embodiments, the second spiral slot 222 may be configured to hold a single turn of a coil. In other embodiments, the second spiral slot 222 may be configured to hold a predetermined number of turns in a coil. In such embodiments, a first portion of the coil may be insulated from another portion of the coil through insulators such as, but not limited to, enamel. The second spiral slot 222 may be generally in the shape of a spiral. In some embodiments, the spiral may be a broken spiral. The turns of the spiral may not be uniform. The second spiral slot 222 may have non-spiral portions configured to facilitate a cross over portion of a coil. The second spiral slot 222 may include a third disc slot section 224 and a fourth disc slot section 226. The third disc slot section 224 may be configured to retain a first portion of a coil. A fourth disc slot section 226 may be configured to retain a second portion of a coil. In such a configuration, the third disc slot section 224 and the fourth disc slot section 226 may work to inhibit direct electrical communication between the two portions of the coil, as this may cause an unwanted short circuit. In some embodiments, the third disc slot section 224 may be radially spaced apart from the fourth disc slot section 226 to facilitate electrical communication inhibition.

The second spacer disc 200 includes a second plurality of cooling channels 208 and a second plurality of horizontal cooling channels 211. The second plurality of cooling channels 208 may be used to allow coolant to flow throughout various portions of a coil. The second plurality of cooling channels 208 may be disposed between the second disc top plane 201 and the second disc bottom plane. The second plurality of cooling channels 208 includes a third vertical cooling channel 210. The third vertical cooling channel 210 may be radially spaced apart from the central axis 10 by a predetermined distance. The third vertical cooling channel 210 may be disposed on the second disc top plane 201. In other embodiments, the third vertical cooling channel 210 may be disposed on the second disc bottom plane. The third vertical cooling channel 210 may run between the second disc top plane 201 and one of the second disc bottom plane, the second disc outer surface 230, and the second disc inner surface 228. The third vertical cooling channel 210 may run between the second disc bottom plane 203 and one of the second disc bottom plane, the second disc outer surface 230, and the second disc inner surface 228. In addition to the third vertical cooling channel 210, the second plurality of cooling channels 208 may include a fourth vertical cooling channel 212. The fourth vertical cooling channel 212 may also be radially spaced apart from the central axis 10 by a predetermined distance. The fourth vertical cooling channel 212 may be further spaced apart from the central axis 10 than the third vertical cooling channel 210. In some embodiments, the fourth vertical cooling channel 212 may be radially aligned with the third vertical cooling channel 210. The fourth vertical cooling channel 212 may be disposed on the second disc top plane 201. In other embodiments, the fourth vertical cooling channel 212 may be disposed on the second disc bottom plane 203. The fourth vertical cooling channel 212 may run between the second disc top plane 201 and one of the second disc bottom plane 203, the second disc outer surface 230, and the second disc inner surface 228. The fourth vertical cooling channel 212 may run between the second disc bottom plane 203 and one of the second disc bottom plane, the second disc outer surface 230, and the second disc inner surface 228.

The second plurality of horizontal cooling channels 211 includes a third horizontal cooling channel 214. The third horizontal cooling channel 214 may be disposed on the second disc inner surface 228. In other embodiments, the third horizontal cooling channel 214 may be disposed on the second disc outer surface 230. The third horizontal cooling channel 214 may run between the second disc inner surface 228 and one of the second disc outer surface 230, the second disc top plane 201, and the second disc bottom plane 203. The third horizontal cooling channel 214 may run between the second disc outer surface 230 and one of the second disc inner surface 228, the second disc top plane 201, and the second disc bottom plane 203. The second plurality of horizontal cooling channels 211 includes a fourth horizontal cooling channel 216. The fourth horizontal cooling channel 216 may be axially spaced apart from the third horizontal cooling channel 214. The fourth horizontal cooling channel 216 may be axially aligned with the third horizontal cooling channel 214. The fourth horizontal cooling channel 216 may be disposed on the second disc inner surface 228. In other embodiments, the fourth horizontal cooling channel 216 may be disposed on the second disc outer surface 230. The fourth horizontal cooling channel 216 may run between the second disc inner surface 228 and one of the second disc outer surface 230, the second disc top plane 201, and the second disc bottom plane 203. The fourth horizontal cooling channel 216 may run between the second disc outer surface 230 and one of the second disc inner surface 228, the second disc top plane 201, and the second disc bottom plane 203.

In some embodiments, both the first spacer disc 100 and the second spacer disc 200 may be present within a coil assembly. The second spacer disc 200 may be configured to facilitate a coil that is installed in the first spacer disc 100. For example, the second spiral slot 222 of the second spacer disc 200 may be configured to be a continuation of the first spiral slot 122 of the first spacer disc 100. The size of the second spacer disc 200 may be configured to be comparable, if not exact, to the size of the first spacer disc 100. A cutaway section XXX of the second spacer disc 200 may align with a cutaway section XXX of the first spacer disc 100. In some embodiments, the second spacer disc 200 may be configured to be stacked upon the first spacer disc 100 such that the two discs abut. The first spacer disc 100 may be stacked with the second disc spacer 200 such that they are both in alignment with respect to the central axis 10. In these embodiments, the first spacer disc 100 and the second spacer disc 200 may abut to form a disc gap 12. In certain embodiments, a thermal sensor 14 may be placed in the disc gap 12. The thermal sensor 14 may be used to determine a thermal value of a coil in thermal communication with one of the first spacer disc 100 and the second thermal disc 200. The thermal sensor 14 may be, but is not limited to, a fiber optic cable.

The first disc slot section 124 is disposed radially with respect to the second disc slot section 126 within the first spacer disc 100. The third disc slot section 224 is disposed radially with respect to the fourth disc slot section 226 within the second spacer disc 200. In embodiments in which the first spacer disc 100 and the second spacer disc 200 abut, a coil section that is retained within one of the first disc slot section 124 or the second disc slot section 126 may be disposed axially with respect to a different coil section retained within one of the third disc slot section 224 or the fourth disc slot section 226.

When both the first spacer disc 100 and the second spacer disc 200 are disposed adjacent to each other, their respective cooling channels may be in fluid communication. In some embodiments, one of the first vertical cooling channel 110 or the second vertical cooling channel 112 may be in fluid communication with one of the third vertical cooling channel 210 or the fourth vertical cooling channel 212. This arrangement may allow coolant to move through both the first spacer disc 100 and the second spacer disc 200. It may help maintain consistent thermal conditions along the coil assembly and may reduce localized heating.

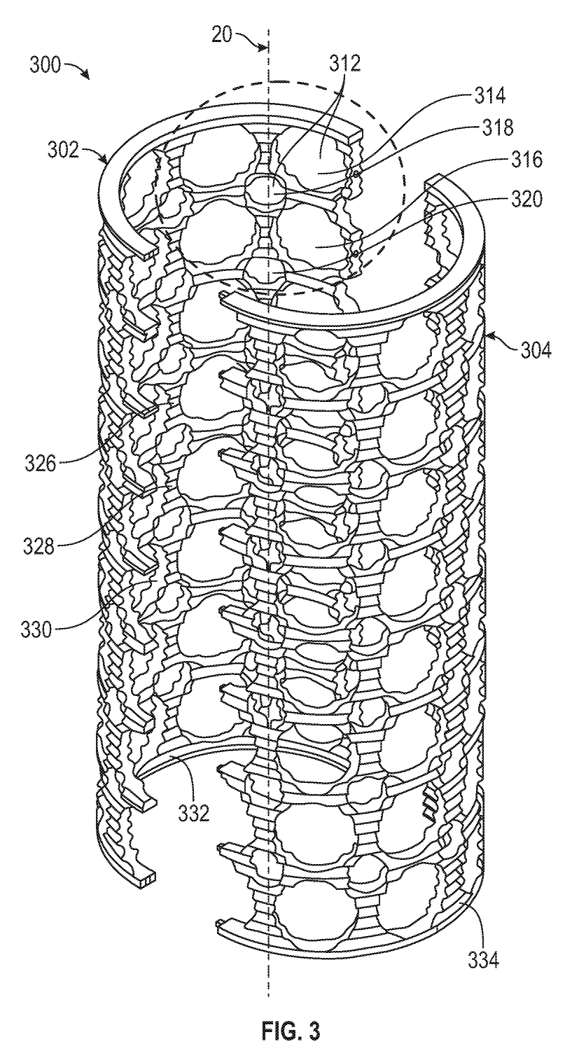

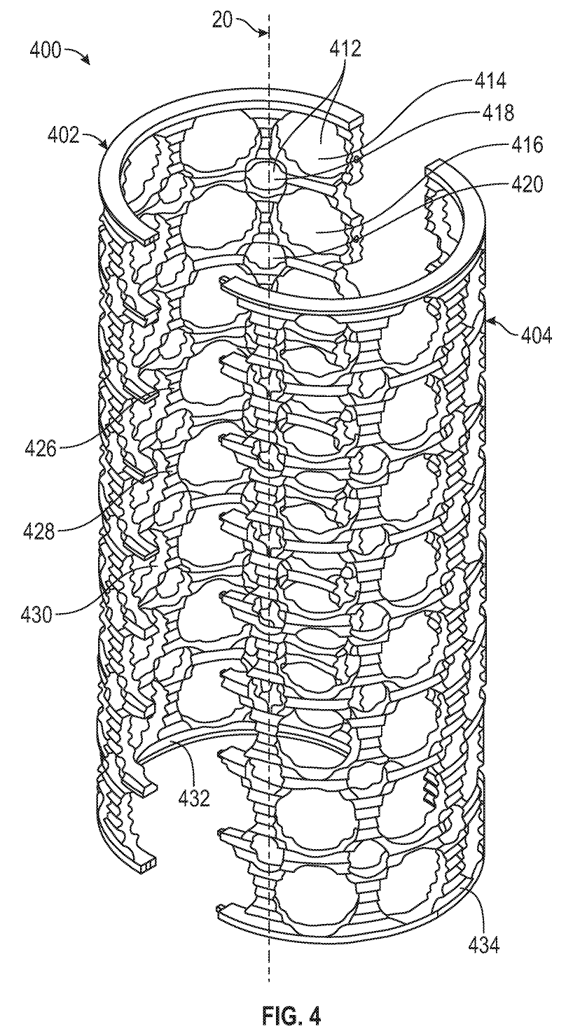

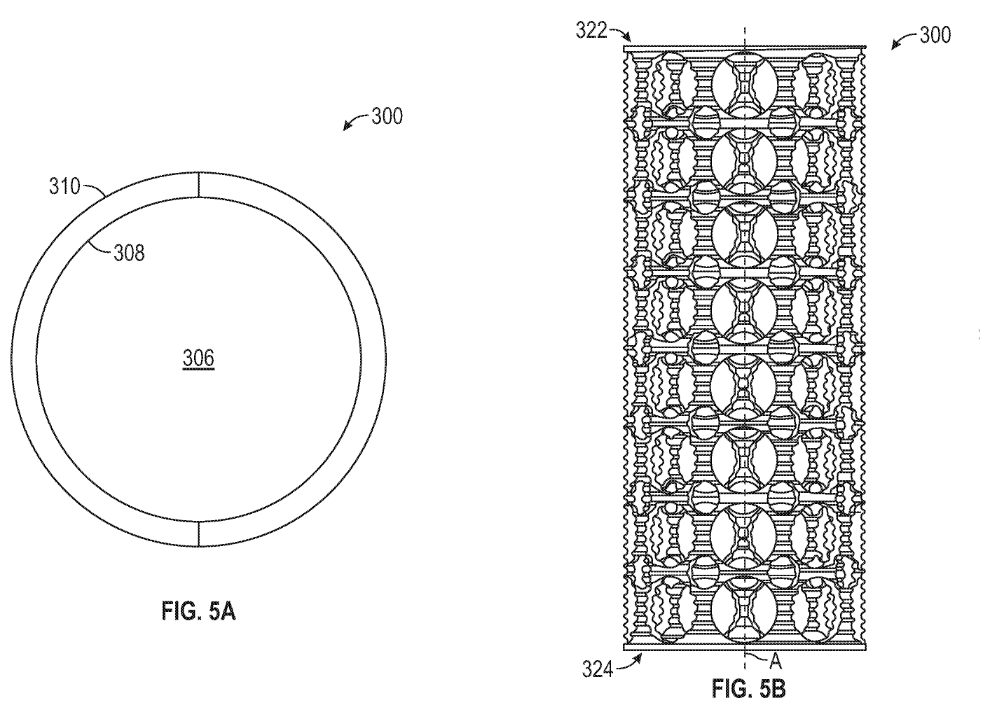

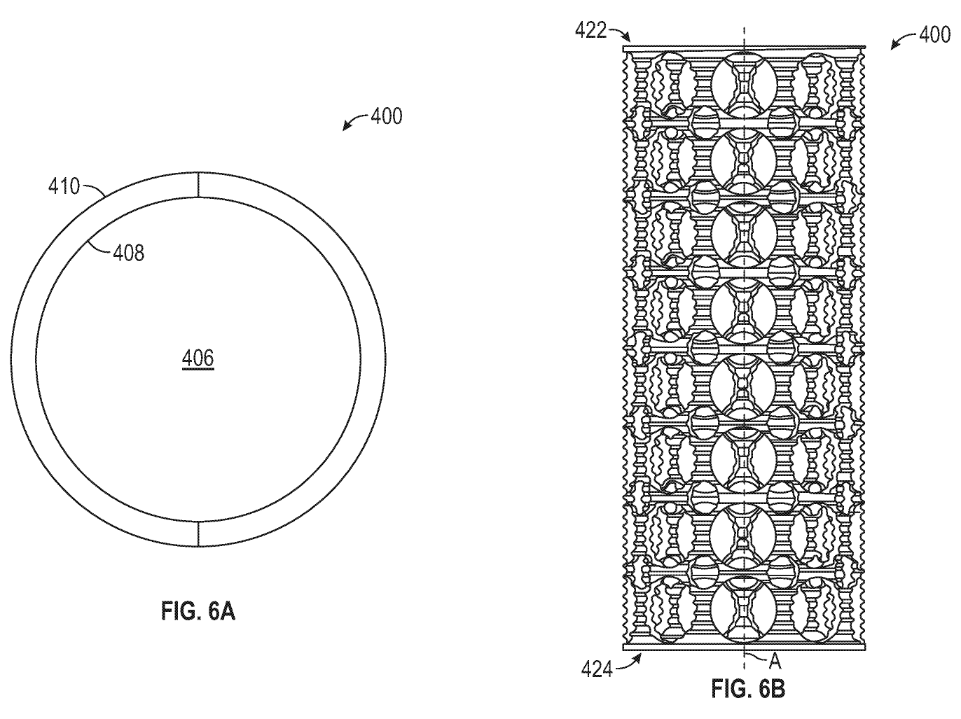

Each of FIGS. 3, 4, 5, and 6 illustrates the cylinder pair of a first spacer cylinder 300 and a second spacer cylinder 400. In some embodiments, the first spacer cylinder 300 may be composed of a first spacer cylinder first portion 302 and a first spacer cylinder second portion 304. In these embodiments, one of the first spacer cylinder first portion 302 and the first spacer cylinder second portion 304 may make up half of the first spacer cylinder 300. In some embodiments, one of the first spacer cylinder first portion 302 and the first spacer cylinder second portion 304 may make up less than half of the first spacer cylinder 300. The first spacer cylinder first portion 302 and the first spacer cylinder second portion 304 may be configured to join and form the first spacer cylinder 300. The first spacer cylinder first portion 302 and the first spacer cylinder second portion 304 may be configured to be joined by various methods, including but not limited to, welding, brazing, soldering, adhesive bonding, and snap-fit connecting.

The first spacer cylinder 300 includes a first cylinder central aperture 306. The first spacer cylinder 300 defines a central axis 20. In particular, the first cylinder central aperture 306 may define the central axis 20. The first spacer cylinder 300 includes a first cylinder inner perimeter 308 and a first cylinder outer perimeter 310. The first cylinder inner perimeter 308 may further define the first cylinder central aperture 306. The first cylinder inner perimeter 308 is radially spaced apart from the central axis 20 by a predetermined distance. The first cylinder outer perimeter 310 is radially spaced apart from the central axis 20 by a predetermined distance that is greater than the first cylinder inner perimeter 308.

The first spacer cylinder 300 includes a first cylinder top surface 322, a first cylinder bottom surface 324, a first cylinder inner surface 332, and a first cylinder outer surface 334. The first cylinder top surface 322 is disposed opposite the first cylinder bottom surface 324. The first cylinder inner surface 332 is disposed opposite the first cylinder outer surface 334. The combination of the first cylinder top surface 322, the first cylinder bottom surface 324, the first cylinder inner surface 332, and the first cylinder outer surface 334 combine to form cylindrical walls. As such, the first cylinder inner surface 332 and the first cylinder outer surface 334 are curved. The curvature of the first cylinder inner surface 332 and the first cylinder outer surface 334 may be uniform. In some embodiments, the curvature of the first cylinder inner surface 332 and the first cylinder outer surface 334 may be non-uniform. As presented, the surface of the first cylinder top surface 322 and the first cylinder bottom surface 324 are flat. In other embodiments, the surface of the first cylinder top surface 322 and the first cylinder bottom surface 324 may be non-planar.

The first spacer cylinder 300 includes a first helical slot 326. The first helical slot 326 may be disposed on the first cylinder inner surface 332. The first helical slot 326 may be shaped as a helix. In some embodiments, the first helical slot 326 is a continuous helix. In other embodiments, the first helical slot 326 may be a broken helix. The rungs of the helix of the first helical slot 326 may be uniformly spaced apart in some embodiments; however, in other embodiments, the space between the rungs of the helix may be non-uniform. The first helical slot 326 is configured to one of receive and retain a coil. One function of the first helical slot 326 is to assist with inhibiting electrical communication between different portions of a coil within a coil, as this will reduce the probability of the coil short circuiting. In particular, the first helical slot 326 includes a first cylinder slot section 328 and a second cylinder slot section 330. Each of the first cylinder slot section 328 and the second cylinder slot section 330 are configured to retain a portion of a coil. In some embodiments, one of the first cylinder slot section 328 and the second cylinder slot section 330 is configured to retain a single turn of a coil. In other embodiments, one of the first cylinder slot section 328 and the second cylinder slot section 330 is configured to retain a predetermined amount of turns of a coil. In the presented embodiment, the first cylinder slot section 328 is axially spaced apart from the second cylinder slot section 330 with respect to the central axis 20.

The first spacer cylinder 300 includes a first plurality of cooling channels 312. The first plurality of cooling channels 312 may be configured to facilitate distribution of cooling fluid to different portions of a coil. The first plurality of cooling channels 312 may be disbursed throughout one of the first cylinder inner surface 332 and the first cylinder outer surface 334. Some channels of the first plurality of cooling channels 312 may flow from one of the first cylinder inner surface 332 to the first cylinder outer surface 334.

The first plurality of cooling channels 312 may include a first large sized cooling channel 314. The first plurality of cooling channels 312 may additionally include a second large sized cooling channel 316. The second large sized cooling channel 316 may be adjacent to the first large sized cooling channel 314. The second large sized cooling channel 316 may be disposed on the first cylinder outer surface 334 and spaced apart from the first large sized cooling channel 314 either angularly, axially, or both.

The first plurality of cooling channels 312 may include a first small sized cooling channel 318. The first plurality of cooling channels 312 may include a second small sized cooling channel 320. Similar to the relationship between the first large sized cooling channel 314 and the second large sized cooling channel 316, the second small sized cooling channel 320 may be disposed on the first cylinder outer surface 334 and spaced apart from the first small sized cooling channel 318 either angularly, axially, or both. Even further, one of the first large sized cooling channel 314 and the second large sized cooling channel 316 may be spaced apart from one of the first small sized cooling channel 318 and the second small sized cooling channel 320 either angularly, axially, or both. One of the first large sized cooling channel 314, the second large sized cooling channel 316, the first small sized cooling channel 318, and the second small sized cooling channel 320 may be in fluid communication with another of the first large sized cooling channel 314, the second large sized cooling channel 316, the first small sized cooling channel 318, and the second small sized cooling channel 320.

In some embodiments, the second spacer cylinder 400 may be composed of a second spacer cylinder first portion 402 and a second spacer cylinder second portion 404. In these embodiments, one of the second spacer cylinder first portion 402 and the second spacer cylinder second portion 404 may make up half of the second spacer cylinder 400. In some embodiments, one of the second spacer cylinder first portion 402 and the second spacer cylinder second portion 404 may make up less than half of the second spacer cylinder 400. The second spacer cylinder first portion 402 and the second spacer cylinder second portion 404 may be configured to join and form the second spacer cylinder 400. The second spacer cylinder first portion 402 and the second spacer cylinder second portion 404 may be configured to be joined by various methods, including but not limited to, welding, brazing, soldering, adhesive bonding, and snap-fit connecting.

The second spacer cylinder 400 includes a second cylinder central aperture 406. The second spacer cylinder 400 defines the central axis 20. In particular, the second cylinder central aperture 406 may define the central axis 20. The second spacer cylinder 400 includes a second cylinder inner perimeter 408 and a second cylinder outer perimeter 410. The second cylinder inner perimeter 408 may further define the second cylinder central aperture 406. The second cylinder inner perimeter 408 is radially spaced apart from the central axis 20 by a predetermined distance. The second cylinder outer perimeter 410 is radially spaced apart from the central axis 20 by a predetermined distance that is greater than the second cylinder inner perimeter 408.

The second spacer cylinder 400 includes a second cylinder top surface 422, a second cylinder bottom surface 424, a second cylinder inner surface 432, and a second cylinder outer surface 434. The second cylinder top surface 422 is disposed opposite the second cylinder bottom surface 424. The second cylinder inner surface 432 is disposed opposite the second cylinder outer surface 434. The combination of the second cylinder top surface 422, the second cylinder bottom surface 424, the second cylinder inner surface 432, and the second cylinder outer surface 434 combine to form cylindrical walls. As such, the second cylinder inner surface 432 and the second cylinder outer surface 434 are curved. The curvature of the second cylinder inner surface 432 and the second cylinder outer surface 434 may be uniform. In some embodiments, the curvature of the second cylinder inner surface 432 and the second cylinder outer surface 434 may be non-uniform. As presented, the surface of the second cylinder top surface 422 and the second cylinder bottom surface 424 are flat. In other embodiments, the surface of the second cylinder top surface 422 and the second cylinder bottom surface 424 may be non-planar.

The second spacer cylinder 400 includes a second helical slot 426. The second helical slot 426 may be disposed on the second cylinder inner surface 432. The second helical slot 426 may be shaped as a helix. In some embodiments, the second helical slot 426 is a continuous helix. In other embodiments, the second helical slot 426 may be a broken helix. The rungs of the helix of the second helical slot 426 may be uniformly spaced apart in some embodiments; however, in other embodiments, the space between the rungs of the helix may be non-uniform. The second helical slot 426 is configured to one of receive and retain a coil. One function of the second helical slot 426 is to assist with inhibiting electrical communication between different portions of a coil within a coil, as this will reduce the probability of the coil short circuiting. In particular, the second helical slot 426 includes a third cylinder slot section 428 and a fourth cylinder slot section 430. Each of the third cylinder slot section 428 and the fourth cylinder slot section 430 are configured to retain a portion of a coil. In some embodiments, one of the third cylinder slot section 428 and the fourth cylinder slot section 430 is configured to retain a single turn of a coil. In other embodiments, one of the third cylinder slot section 428 and the fourth cylinder slot section 430 are configured to retain a predetermined amount of turns of a coil. In the presented embodiment, the third cylinder slot section 428 is axially spaced apart from the fourth cylinder slot section 430 with respect to the central axis 20.

The second spacer cylinder 400 includes a second plurality of cooling channels 412. The second plurality of cooling channels 412 may be configured to facilitate distribution of cooling fluid to different portions of a coil. The second plurality of cooling channels 412 may be disbursed throughout one of the second cylinder inner surface 432 and the second cylinder outer surface 434. Some channels of the second plurality of cooling channels 412 may flow from one of the second cylinder inner surface 432 to the second cylinder outer surface 434.

The second plurality of cooling channels 412 may include a third large sized cooling channel 414. The second plurality of cooling channels 412 may additionally include a fourth large sized cooling channel 416. The fourth large sized cooling channel 416 may be adjacent to the third large sized cooling channel 414. The fourth large sized cooling channel 416 may be disposed on the second cylinder outer surface 434 and spaced apart from the third large sized cooling channel 414 either angularly, axially, or both.

The second plurality of cooling channels 412 may include a third small sized cooling channel 418. The second plurality of cooling channels 412 may include a fourth small sized cooling channel 420. Similar to the relationship between the third large sized cooling channel 414 and the fourth large sized cooling channel 416, the fourth small sized cooling channel 420 may be disposed on the second cylinder outer surface 434 and spaced apart from the third small sized cooling channel 418 either angularly, axially, or both. Even further, one of the third large sized cooling channel 414 and the fourth large sized cooling channel 416 may be spaced apart from one of the third small sized cooling channel 418 and the fourth small sized cooling channel 420 either angularly, axially, or both. One of the third large sized cooling channel 414, the fourth large sized cooling channel 416, the third small sized cooling channel 418, and the fourth small sized cooling channel 420 may be in fluid communication with another of the third large sized cooling channel 414, the fourth large sized cooling channel 416, the third small sized cooling channel 418, and the fourth small sized cooling channel 420.

In some embodiments, both the first spacer cylinder 300 and the second spacer cylinder 400 may be present within a coil assembly. The second spacer cylinder 400 may be configured to facilitate a coil that is installed within the first spacer cylinder 300. For example, the second helical slot 426 of the second spacer cylinder 400 may be configured to be a continuation of the first helical slot 326 of the first spacer cylinder 300. The size of the second spacer cylinder 400 may be configured to be larger than the size of the first spacer cylinder 300 to facilitate concentric orientation of the first spacer cylinder 300 within the second spacer cylinder 400. A cutaway section XXX of the second spacer cylinder 400 may align with a cutaway section XXX of the first spacer cylinder 300. In some embodiments, the second spacer cylinder 400 may be configured to be placed concentrically around the first spacer cylinder 300 such that the two cylinders share the same central axis 20. The first spacer cylinder 300 may be arranged within the second spacer cylinder 400 so that both are aligned with respect to the central axis 20. In these embodiments, the first spacer cylinder 300 and the second spacer cylinder 400 may define a cylinder gap 22. In certain embodiments, a thermal sensor 24 may be placed in the cylinder gap 22. The thermal sensor 24 may be used to determine a thermal value of a coil in thermal communication with one of the first spacer cylinder 300 and the second spacer cylinder 400. The thermal sensor 24 may be, but is not limited to, a fiber optic cable.

The first cylinder slot section 328 is disposed axially with respect to the second cylinder slot section 330 within the first spacer cylinder 300. The third cylinder slot section 428 is disposed axially with respect to the fourth cylinder slot section 430 within the second spacer cylinder 400. In embodiments in which the first spacer cylinder 300 and the second spacer cylinder 400 are arranged concentrically, a coil section that is retained within one of the first cylinder slot section 328 or the second cylinder slot section 330 may be disposed radially with respect to a different coil section retained within one of the third cylinder slot section 428 or the fourth cylinder slot section 430.

When both the first spacer cylinder 300 and the second spacer cylinder 400 are arranged concentrically, their respective cooling channels may be in fluid communication. In some embodiments, one of the first large sized cooling channel 314 or the second large sized cooling channel 316 may be in fluid communication with one of the third large sized cooling channel 414 or the fourth large sized cooling channel 416. This arrangement may allow coolant to move through both the first spacer cylinder 300 and the second spacer cylinder 400. It may help maintain consistent thermal conditions along the coil assembly and may reduce localized heating. By creating a continuous cooling path, the coolant may transfer heat away from critical coil regions and thereby facilitate stable transformer operation.

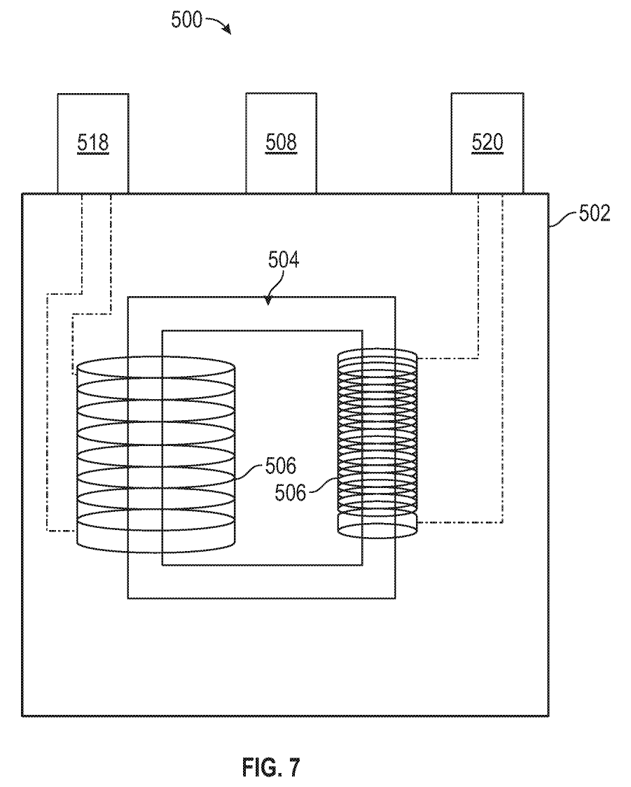

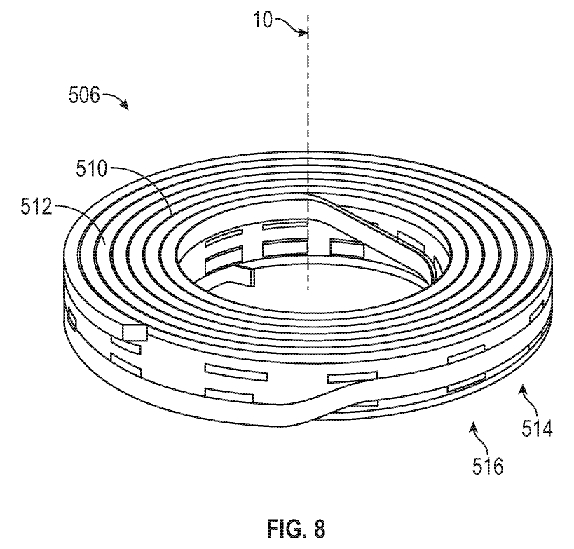

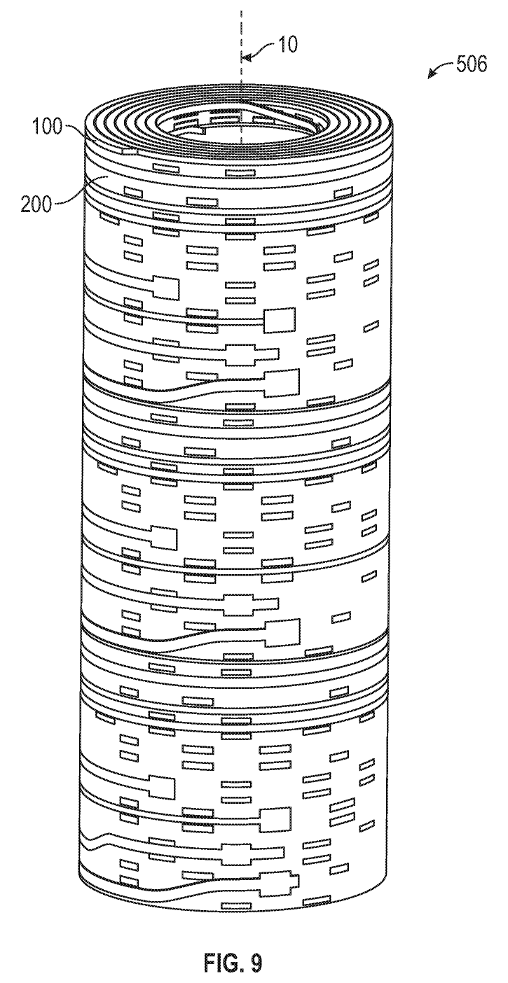

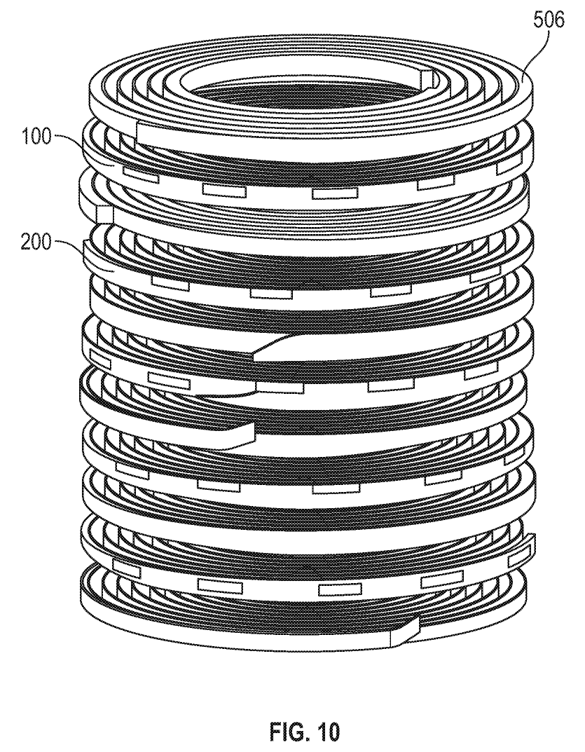

Each of FIGS. 7, 8, 9 and 10 illustrates the components of a high-ratio transformer 500. The high-ratio transformer 500 may be used for applications involving the transformation of high power, or any other suitable applications. The high-ratio transformer 500 includes a high-ratio transformer housing 502, a high-ratio transformer core 504, a high-ratio transformer coil 506, and a high-ratio cooling system 508. The high-ratio transformer housing 502 in a high-ratio transformer 500 may be configured to store all the components of the high-ratio transformer 500 as well as retain cooling fluids of the high-ratio transformer 500. The high-ratio transformer core 504 may be used to direct magnetic flux. The high-ratio transformer core 504 may be composed of a ferromagnetic material, such as laminated iron, or any other suitable material. The high-ratio transformer 500 also includes a high-ratio transformer input 518 as well as a high-ratio transformer output 520. Each of the high-transformer input 518 and high-transformer output 520 are configured to electrically communicate to each other via the high-ratio transformer core 504 and the high-ratio transformer coil 506.

The high-ratio transformer coil 506 is disposed around the high-ratio transformer core 504. The high-ratio transformer coil 506 is at least partially disposed in a combination of the first spacer disc 100 and the second spacer disc 200. The high-ratio transformer coil 506 includes a high-ratio transformer coil first section 510, a high-ratio transformer coil second section 512, a high-ratio transformer coil third section 514, and a high-ratio transformer coil fourth section 516. In some embodiments, the high-ratio transformer coil first section 510 and the high-ratio transformer coil second section 512 may be disposed in the first spacer disc 100, while the high-ratio transformer coil third section 514 and the high-ratio transformer coil fourth section 516 are disposed in the second spacer disc 200. In particular, the high-ratio transformer coil first section 510 may be disposed in the first disc slot section 124, the high-ratio transformer coil second section 512 may be disposed in the second disc slot section 126, the high-ratio transformer coil third section 514 may be disposed in the third disc slot section 224, and the high-ratio transformer coil fourth section 516 may be disposed in the fourth disc slot section 226. In such embodiments, the high-ratio transformer coil first section 510 is radially spaced apart from the high-ratio transformer coil second section 512, while both the high-ratio transformer coil first section 510 and the high-ratio transformer coil second section 512 are axially spaced apart from the high-ratio transformer coil third section 514 and the high-ratio transformer coil fourth section 516.

The high-ratio cooling system 508 is employed to remove thermal load from the high-ratio transformer 500. The high-ratio cooling system 508 may be in fluid communication with any and all coolant channels of either the first spacer disc 100 or the second spacer disc 200. In particular, the high-ratio cooling system 508 may be in fluid communication with at least one of the first vertical cooling channel 110, the second vertical cooling channel 112, the first horizontal cooling channel 114, the second horizontal cooling channel 116, the third vertical cooling channel 210, the fourth vertical cooling channel 212, the third horizontal cooling channel 214, and the fourth horizontal cooling channel 216.

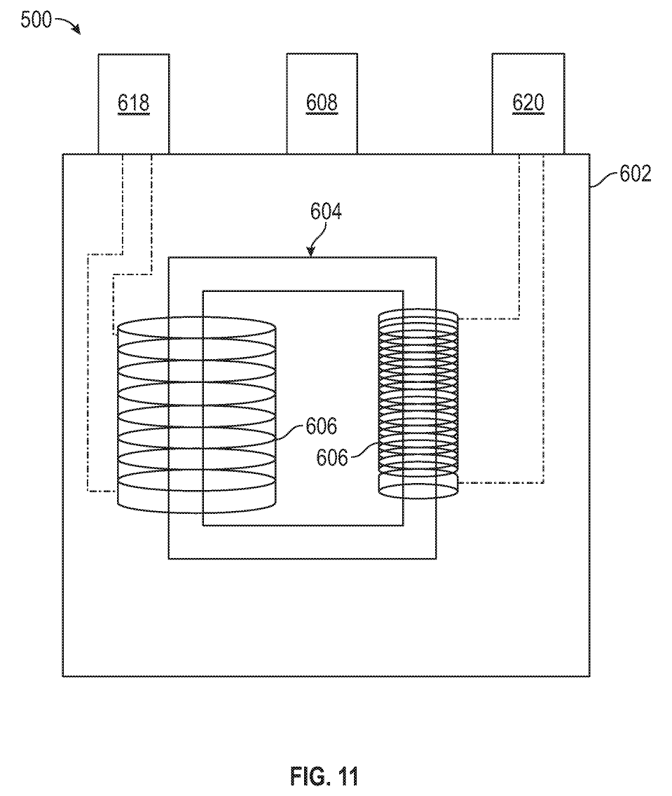

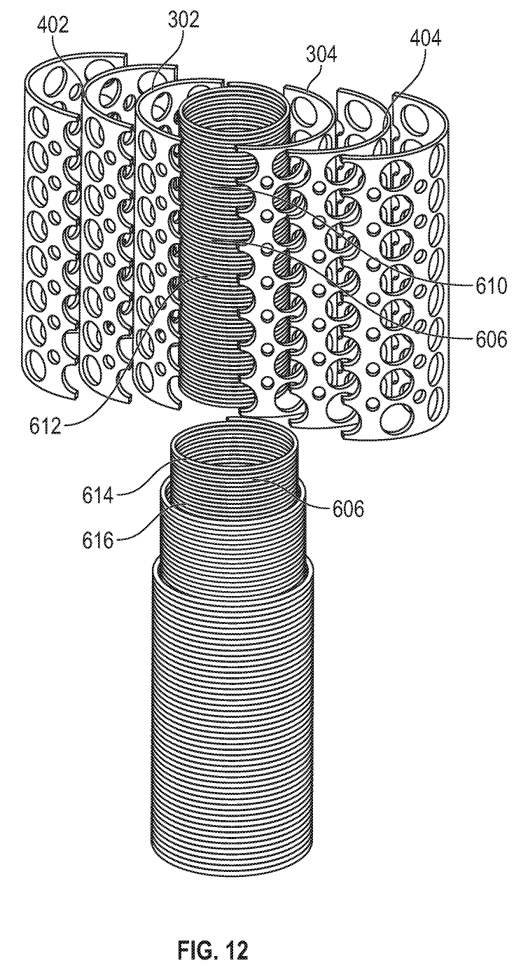

Each of FIGS. 11 and 12 illustrates the components of a low-ratio transformer 600. The low-ratio transformer 600 may be employed for applications involving the transformation of relatively low power. The low-ratio transformer 600 includes a low-ratio transformer housing 602, a low-ratio transformer core 604, a low-ratio transformer coil 606, and a low-ratio cooling system 608. The low-ratio transformer housing 602 in a low-ratio transformer 600 may be configured to hold all components of the low-ratio transformer 600 and to retain cooling fluids associated with the low-ratio transformer 600. The low-ratio transformer core 604 may be used to direct magnetic flux. The low-ratio transformer core 604 may be composed of a ferromagnetic material, such as laminated iron or any other suitable material. The low-ratio transformer 600 also includes a low-ratio transformer input 618 as well as a low-ratio transformer output 620. Each of the low-transformer input 618 and low-transformer output 620 are configured to electrically communicate to each other via the low-ratio transformer core 604 and the low-ratio transformer coil 606.

The low-ratio transformer coil 606 may be helical and may be disposed around the low-ratio transformer core 604. The low-ratio transformer coil 606 may be at least partially disposed in a combination of the first spacer cylinder 300 and the second spacer cylinder 400. The low-ratio transformer coil 606 may include a low-ratio transformer coil first section 610, a low-ratio transformer coil second section 612, a low-ratio transformer coil third section 614, and a low-ratio transformer coil fourth section 616. In some embodiments, the low-ratio transformer coil first section 610 may be disposed in the first cylinder slot section 328 of the first spacer cylinder 300, and the low-ratio transformer coil second section 612 may be disposed in the second cylinder slot section 330 of the first spacer cylinder 300. The low-ratio transformer coil third section 614 may be disposed in the third cylinder slot section 428 of the second spacer cylinder 400, and the low-ratio transformer coil fourth section 616 may be disposed in the fourth cylinder slot section 430 of the second spacer cylinder 400. In particular, the low-ratio transformer coil first section 610 is axially spaced apart from the low-ratio transformer coil second section 612, while both the low-ratio transformer coil first section 610 and the low-ratio transformer coil second section 612 are radially spaced apart from the low-ratio transformer coil third section 614 and the low-ratio transformer coil fourth section 616.

The low-ratio cooling system 608 may be employed to remove thermal load from the low-ratio transformer 600. The low-ratio cooling system 608 may be in fluid communication with any or all coolant channels of either the first spacer cylinder 300 or the second spacer cylinder 400. In particular, the low-ratio cooling system 608 may be in fluid communication with at least one of the first large sized cooling channel 314, the second large sized cooling channel 316, the first small sized cooling channel 318, the second small sized cooling channel 320, the third large sized cooling channel 414, the fourth large sized cooling channel 416, the third small sized cooling channel 418, and the fourth small sized cooling channel 420.

The foregoing detailed description refers to various examples of thermoplastic coil spacers. The description and appended drawings illustrating the described thermoplastic coil spacers are intended to only provide examples and not to limit the scope of the claims in any manner.

What is claimed is:

1. A transformer comprising:
an electrically conductive coil defining a central axis, the coil including a first coil section and a second coil section radially spaced apart from the first coil section with respect to the central axis; and
a hydrophobic thermoplastic coil first spacer configured to receive and partially house the electrically conductive coil, the first spacer being configured to inhibit electrical communication between the first coil section and the second coil section.

2. The transformer of claim 1, wherein the first spacer further defines a first coolant channel configured to facilitate the flow of and allow thermal communication between a coolant solution and the coil.

3. The transformer of claim 1, wherein the thermoplastic is one of polyphenylene sulfide plastic, liquid crystal polymer plastic, and other high-performance thermoplastics.

4. The transformer of claim 1, wherein the first spacer defines a disc.

5. The transformer of claim 4, wherein the first spacer defines a slotted spiral channel within the disc.

6. The transformer of claim 5, wherein the first spacer includes both an exterior surface that defines a first slotted aperture and an interior surface that defines a second slotted aperture, and
wherein the exterior surface is spaced further from the central axis than the interior surface.

7. The transformer of claim 1, wherein the coil further defines a third coil section axially spaced apart from one of the first coil section and the second coil section, and
wherein the transformer further comprises a hydrophobic thermoplastic coil second spacer configured to receive and partially house the electrically conductive coil, the second spacer being spaced axially spaced apart from the first spacer with respect to the central axis, and being configured to inhibit electrical communication between the third coil section and one of the first coil section and the second coil section.

8. The transformer of claim 7, wherein the second spacer further defines a second coolant channel configured to facilitate the flow of and allow thermal communication between a coolant solution and the coil, and
wherein the second coolant channel is in fluid communication with the first fluid channel.

9. The transformer of claim 7, further comprising a sensor disposed between the first spacer and the second spacer configured to monitor the temperature of the transformer.

10. The transformer of claim 9, wherein the sensor is a fiber optic cable.

11. A transformer comprising:
an electrically conductive coil defining a central axis, the coil including a first coil section and a second coil section axially spaced apart from the first coil section with respect to the central axis; and
a hydrophobic thermoplastic coil inner spacer configured to receive and partially house the electrically conductive coil, the inner spacer being configured to inhibit electrical communication between the first coil section and the second coil section.

12. The transformer of claim 11, wherein the inner spacer further defines an inner coolant channel configured to facilitate the flow of and allow thermal communication between a coolant solution and the coil.

13. The transformer of claim 11, wherein the thermoplastic is one of polyphenylene sulfide plastic and liquid crystal polymer plastic.

14. The transformer of claim 11, wherein the inner spacer is defined by a first spacer section and a second spacer section.

15. The transformer of claim 14, wherein the inner spacer section is a half of the spacer.

16. The transformer of claim 11, wherein the inner spacer defines a helical slot.

17. The transformer of claim 11, wherein the coil further defines a third coil section radially spaced apart from one of the first coil section and the second coil section, and
wherein the transformer further comprises a hydrophobic thermoplastic coil outer spacer configured to receive and partially house the electrically conductive coil, the outer spacer being spaced radially apart from the inner spacer with respect to the central axis, and being configured to inhibit electrical communication between the third coil section and one of the first coil section and the second coil section.

18. The transformer of claim 17, wherein the outer spacer further defines an outer coolant channel configured to facilitate the flow of and allow thermal communication between a coolant solution and the coil, and
wherein the outer coolant channel is in fluid communication with the inner fluid channel.

19. The transformer of claim 18, further comprising a sensor disposed between the inner spacer and the outer spacer configured to monitor the temperature of the transformer.

20. A coil monitoring method comprising:
providing a hydrophobic thermoplastic first disc that defines a first central aperture that further defines a central axis, the first disc further defining a first slot section and a second slot section, wherein each of the first slot section and second slot section is configured to receive a corresponding coil section from a plurality of coil sections of a coil such that a first coil section of the plurality of coil sections is radially spaced apart from a second coil section with respect to the central axis;
disposing a hydrophobic thermoplastic second disc that defines a second central aperture that further defines a central axis, the second disc further defining a third slot section and a further slot section, wherein each of the third slot section and the fourth slot section is configured to receive a corresponding coil section from the plurality of coil sections of the coil such that a third coil section of the plurality of coil sections is radially spaced apart from a fourth coil section with respect to the central axis adjacent to the first disc, such that the first disc and second disc combine to define a gap; and
disposing a temperature sensor within the gap.
